(19) United States
(12) Patent Application Publication
(10) Pub. No.: US 2026/0279654 A1
(43) Pub. Date: Sep. 17, 2026

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Kojiro KOMAGAKI, Nagaokakyo-shi (JP); Masashi HATTORI, Nagaokakyo-shi (JP)

(73) Assignee: Murata Manufacturing Co., Ltd., Kyoto-fu (JP)

(21) Appl. No.: 19/669,821

(22) Filed: May 6, 2026

Related U.S. Application Data
(63) Continuation of application No. PCT/JP2024/019406, filed on May 27, 2024.

(30) Foreign Application Priority Data
Nov. 9, 2023 (JP) 2023-191722

(51) Int. Cl. H01F 27/28; H01F 27/29

(52) U.S. Cl. CPC H01F 27/2804; H01F 27/292; H01F 2027/2809

(57) ABSTRACT

An inductor component includes at least one inductor element. The inductor element includes a magnetic layer having uniaxial magnetic anisotropy, a first inductor wire located on one side of the magnetic layer in a first direction and extending along an imaginary plane that intersects the first direction, a second inductor wire located on the other side of the magnetic layer in the first direction, and a first via portion that electrically connects the first inductor wire and the second inductor wire. The first inductor wire, the second inductor wire, and the first via portion constitute at least part of an inductor wound around an axis extending along a second direction that intersects the first direction. An absolute value of an angle formed between a hard axis or easy axis of the magnetic layer and the axis is larger than or equal to zero degrees and smaller than 10 degrees.

### CROSS-REFERENCE TO RELATED APPLICATIONS

This application claims benefit of priority to International Patent Application No. PCT/JP 2024/019406, filed May 27, 2024, and to Japanese Patent Application No. 2023-191722, filed Nov. 9, 2023, the entire contents of each are incorporated herein by reference.

### BACKGROUND

### Technical Field

The present disclosure relates to an inductor component.

### Background Art

Japanese Unexamined Patent Application Publication No. 2000-252127 discloses a wire-wound magnetic thin film inductor. In the inductor disclosed in Japanese Unexamined Patent Application Publication No. 2000-252127, magnetic thin films are formed on a glass substrate.

### SUMMARY

In the inductor disclosed in Japanese Unexamined Patent Application Publication No. 2000-252127, since the glass substrate needs to need to be thickened in order to wind a wire, miniaturization is difficult, so the efficiency of obtaining inductance may decrease.

Accordingly, the present disclosure to provide an inductor component that can be miniaturized and has high efficiency of obtaining inductance.

An inductor component according to an aspect of the present disclosure includes at least one inductor element. The inductor element includes a magnetic layer having uniaxial magnetic anisotropy, a first inductor wire located on one side of the magnetic layer in a first direction and extending along an imaginary plane that intersects the first direction, a second inductor wire located on the other side of the magnetic layer in the first direction, and a first via portion electrically connecting the first inductor wire and the second inductor wire. The first inductor wire, the second inductor wire, and the first via portion constitute at least part of an inductor wound around an axis extending along a second direction that intersects the first direction. An absolute value of an angle formed between a hard axis or easy axis of the magnetic layer and the axis is larger than or equal to zero degrees and smaller than 10 degrees (i.e. from zero degrees to smaller than 10 degrees).

With the inductor component according to the above aspect, it is possible to realize an inductor component that can be miniaturized and that has high efficiency of obtaining inductance.

### BRIEF DESCRIPTION OF THE DRAWINGS

FIG. 1 is a schematic plan view that shows an inductor component according to an embodiment of the present disclosure;

FIG. 2 is a schematic cross-sectional view taken along the line X1-X2 in FIG. 1;

FIG. 3 is a schematic cross-sectional view taken along the line Y1-Y2 in FIG. 1;

FIG. 4 is a graph that shows an example of the B-H curve of a magnetic layer of the inductor component shown in FIG. 1;

FIG. 5 is a first schematic cross-sectional view for illustrating an example of a manufacturing method for the inductor component shown in FIG. 1;

FIG. 6 is a second schematic cross-sectional view for illustrating an example of the manufacturing method for the inductor component shown in FIG. 1;

FIG. 7 is a third schematic cross-sectional view for illustrating an example of the manufacturing method for the inductor component shown in FIG. 1;

FIG. 8 is a fourth schematic cross-sectional view for illustrating an example of the manufacturing method for the inductor component shown in FIG. 1;

FIG. 9 is a fifth schematic cross-sectional view for illustrating an example of the manufacturing method for the inductor component shown in FIG. 1;

FIG. 10 is a sixth schematic cross-sectional view for illustrating an example of the manufacturing method for the inductor component shown in FIG. 1;

FIG. 11 is a seventh schematic cross-sectional view for illustrating an example of the manufacturing method for the inductor component shown in FIG. 1;

FIG. 12 is an eighth schematic cross-sectional view for illustrating an example of the manufacturing method for the inductor component shown in FIG. 1;

FIG. 13 is a ninth schematic cross-sectional view for illustrating an example of the manufacturing method for the inductor component shown in FIG. 1;

FIG. 14 is a tenth schematic cross-sectional view for illustrating an example of the manufacturing method for the inductor component shown in FIG. 1;

FIG. 15 is an eleventh schematic cross-sectional view for illustrating an example of the manufacturing method for the inductor component shown in FIG. 1;

FIG. 16 is a twelfth schematic cross-sectional view for illustrating an example of the manufacturing method for the inductor component shown in FIG. 1;

FIG. 17 is a schematic plan view that shows a first modification of the inductor component shown in FIG. 1;

FIG. 18 is a cross-sectional view taken along the line A1-A2 in FIG. 17;

FIG. 19 is a cross-sectional view taken along the line B1-B2 in FIG. 17;

FIG. 20 is a schematic cross-sectional view that shows a second modification of the inductor component shown in FIG. 1;

FIG. 21 is a cross-sectional view taken along the line Z1-Z2 in FIG. 20;

FIG. 22 is a schematic plan view that shows a third modification of the inductor component shown in FIG. 1;

FIG. 23 is a schematic plan view that shows a fourth modification of the inductor component shown in FIG. 1;

FIG. 24 is a view that shows the positions of external terminals of the inductor component shown in FIG. 23;

FIG. 25 is a diagram that shows the inductors of the inductor component shown in FIG. 23;

FIG. 26 is a schematic plan view that shows a fifth modification of the inductor component shown in FIG. 1;

FIG. 27 is a view that shows the positions of external terminals of the inductor component shown in FIG. 26;

FIG. 28 is a diagram that shows the inductors of the inductor component shown in FIG. 26;

FIG. 29 is a cross-sectional view taken along the line C1-C2 in FIG. 26;

FIG. 30 is a schematic cross-sectional view that shows a sixth modification of the inductor component shown in FIG. 1;

FIG. 31 is a first view for illustrating an example of a method of forming a magnetic layer of an inductor component shown in FIG. 30;

FIG. 32 is a second view for illustrating an example of a method of forming a magnetic layer of the inductor component shown in FIG. 30;

FIG. 33 is a first view for illustrating an example of a method of forming a magnetic layer different from that of the inductor component shown in FIG. 30; and

FIG. 34 is a second view for illustrating an example of a method of forming a magnetic layer different from that of the inductor component shown in FIG. 30.

### DETAILED DESCRIPTION

Various aspects of the present disclosure will be described.

An inductor component according to a first aspect includes at least one inductor element. The inductor element includes a magnetic layer having uniaxial magnetic anisotropy, a first inductor wire located on one side of the magnetic layer in a first direction and extending along an imaginary plane that intersects the first direction, a second inductor wire located on the other side of the magnetic layer in the first direction, and a first via portion electrically connecting the first inductor wire and the second inductor wire. The first inductor wire, the second inductor wire, and the first via portion constitute at least part of an inductor wound around an axis extending along a second direction that intersects the first direction. An absolute value of an angle formed between a hard axis or easy axis of the magnetic layer and the axis is larger than or equal to zero degrees and smaller than 10 degrees (i.e. from zero degrees to smaller than 10 degrees).

With the inductor component according to the first aspect, since most of the magnetic flux is oriented toward the anisotropy axis, the efficiency of obtaining inductance can be improved, and the direct-current superposition characteristics can be improved. Since the first inductor wire extending along the imaginary plane, the second inductor wire, and the first via portion constitute part of the inductor, the inductor component can be easily miniaturized (for example, reduced in thickness).

According to a second aspect, in the inductor component according to the first aspect, an absolute value of an angle formed between the easy axis and the axis is larger than or equal to zero degrees and smaller than 10 degrees (i.e., from zero degrees to smaller than 10 degrees).

With the inductor component according to the second aspect, since most of the magnetic flux passes through the easy axis, the efficiency of obtaining inductance with the inductor component can be improved.

According to a third aspect, in the inductor component according to the first aspect, an absolute value of an angle formed between the hard axis and the axis is larger than or equal to zero degrees and smaller than 10 degrees (i.e., from zero degrees to smaller than 10 degrees).

With the inductor component according to the third aspect, since most of the magnetic flux passes through the hard axis, the direct-current superposition characteristics of the inductor component can be improved, and iron loss can be reduced.

According to a fourth aspect, in the inductor component according to any one of the first to third aspects, the magnetic layer has a rectangular shape when viewed along the first direction, and the easy axis extends along a long-side direction of the magnetic layer.

With the inductor component according to the fourth aspect, when the influence of shape magnetic anisotropy is considered, the anisotropy axis can be easily controlled by setting the long-side direction of the magnetic layer as the easy axis.

According to a fifth aspect, in the inductor component according to any one of the first to fourth aspects, the magnetic layer includes an inorganic electrically insulating layer and an inorganic magnetic layer that are laminated along the first direction, and a thickness, which is a dimension in the first direction, of the magnetic layer is less than the thickness of the first inductor wire and the thickness of the second inductor wire.

With the inductor component according to the fifth aspect, eddy currents reduce, so the quality factor of the inductor can be increased.

According to a sixth aspect, in the inductor component according to the fifth aspect, the inorganic electrically insulating layers are located at opposite ends of the magnetic layer in the first direction.

With the inductor component according to the sixth aspect, electrical insulation between the inductor component and peripheral members such as wires can be reliably ensured.

According to a seventh aspect, the inductor component according to any one of the first to sixth aspects further includes an external terminal having a recessed portion that is recessed toward the magnetic layer.

With the inductor component according to the seventh aspect, the connection area of the external terminal is increased due to the recessed portion, so the adhesion strength of the external terminal can be improved.

According to an eighth aspect, in the inductor component according to any one of the first to seventh aspects, at least part of the first via portion overlaps the magnetic layer when viewed along the axis.

With the inductor component according to the eighth aspect, since the magnetic flux can be blocked by the first via portion, noise leakage to the surroundings of the inductor component can be suppressed.

According to a ninth aspect, in the inductor component according to the eighth aspect, more than half of the magnetic layer overlaps the first via portion when viewed along the axis.

With the inductor component according to the ninth aspect, noise leakage to the surroundings can be more reliably suppressed.

According to a tenth aspect, in the inductor component according to any one of the first to ninth aspects, the first via portion penetrates the magnetic layer along the first direction.

With the inductor component according to the tenth aspect, since the magnetic layer can be maximized along the imaginary plane, it is possible to suppress leakage flux while enhancing the efficiency of obtaining inductance with the inductor component.

According to an eleventh aspect, the inductor component according to any one of the first to eleventh aspects further includes a first electrically insulating layer covering the first inductor wires; and a second electrically insulating layer located farther from the magnetic layer in the first direction than the first electrically insulating layer and having a lower coefficient of linear expansion than the first electrically insulating layer.

With the inductor component according to the eleventh aspect, for example, by connecting the substrate with the second electrically insulating layer interposed therebetween, the strength of the substrate can be improved.

According to a twelfth aspect, the inductor component according to the eleventh aspect further includes a vertical wire penetrating the second electrically insulating layer along the first direction, the vertical wire being configured to be electrically connectable to an external circuit.

With the inductor component according to the twelfth aspect, the vertical wire can improve the flexibility of the mounting location for the inductor component.

According to a thirteenth aspect, the inductor component according to any one of the first to twelfth aspects further includes an element body having a first main surface and a second main surface respectively located at opposite ends in the first direction, the element body including the magnetic layer, the first inductor wire, the second inductor wire, and the first via portion; and an external terminal provided on at least one of the first main surface and the second main surface, the external terminal being electrically connected to at least one of the first inductor wire and the second inductor wire. A surface roughness of the first main surface and a surface roughness of the second main surface are different from each other.

With the inductor component according to the thirteenth aspect, by performing resin molding on the main surface having a greater surface roughness, the adhesion to the molding material can be improved.

According to a fourteenth aspect, in the inductor component according to the thirteenth aspect, the external terminal is located on the first main surface, the element body has a recessed portion that is recessed from the first main surface toward the magnetic layer in the first direction, and the first main surface is located closer to the magnetic layer than the external terminal.

With the inductor component according to the fourteenth aspect, since the external terminal is located farthest from the magnetic layer, the inductor component can be easily mounted on a substrate or the like.

According to a fifteenth aspect, in the inductor component according to any one of the first to fourteenth aspects, the magnetic layer is located inside an outer periphery of the inductor component when viewed along the first direction.

With the inductor component according to the fifteenth aspect, for example, damage to the magnetic layer due to mechanical stress as a result of cutting during a singulation process can be reduced.

According to a sixteenth aspect, the inductor component according to any one of the first to fifteenth aspects further includes external terminals. The external terminals include a first external terminal electrically connected to at least one of the first inductor wire and the second inductor wire, and a second external terminal that is a dummy terminal not electrically connected to either the first inductor wire or the second inductor wire, and the second external terminal has a shape different from a shape of the first external terminal.

With the inductor component according to the sixteenth aspect, the mounting strength of the inductor component can be improved. By making the shape of the second external terminal different from the shape of the first external terminal, for example, the mounting direction of the inductor component can be easily recognized.

According to a seventeenth aspect, the inductor component according to any one of the first to sixteenth aspects includes a plurality of the inductor elements.

With the inductor component according to the seventeenth aspect, since the single inductor component includes the plurality of inductor elements, the mounting area of the inductor component can be reduced.

According to an eighteenth aspect, in the inductor component according to the seventeenth aspect, a spacing between the first inductor wires or the second inductor wires of the adjacent inductor elements varies along a direction in which the first inductor wires or the second inductor wires extend.

With the inductor component according to the eighteenth aspect, the flexibility of the design regarding the extended position of the external terminal can be improved. The coupling coefficient can be adjusted.

According to a nineteenth aspect, the inductor component according to the seventeenth aspect or the eighteenth aspect includes 2N (where N is a natural number) of the inductor elements.

With the inductor component according to the nineteenth aspect, space for the magnetic layer can be effectively used.

According to a twentieth aspect, in the inductor component according to any one of the first to nineteenth aspects, the magnetic layer has a through-hole provided at a center of the magnetic layer and extending along the first direction.

With the inductor component according to the twentieth aspect, the inductor component having small leakage flux can be realized.

According to a twenty-first aspect, in the inductor component according to any one of the seventeenth to nineteenth aspects, a first axis and a second axis that is parallel to the first axis and that does not overlap the first axis are provided as the axis, a plurality of first sets of the inductors wound around the first axis and a plurality of second sets of the inductors wound around the second axis are provided, and a coupling coefficient of the first sets of the inductors is greater than a coupling coefficient of the second sets of the inductors.

With the inductor component according to the twenty-first aspect, ripple can be suppressed by strengthening the coupling, and the efficiency of the DC-DC converter can be improved by combining a strongly coupled inductor with a weakly coupled inductor for a multi-phase configuration.

According to a twenty-second aspect, in the inductor component according to any one of the first to twenty-first aspects, the magnetic layer has a first end portion facing the first via portion in a third direction that intersects the first direction and the second direction, the first via portion has a second end portion facing the magnetic layer in the third direction, and the first end portion and the second end portion are inclined in the same direction relative to the first direction.

With the inductor component according to the twenty-second aspect, since the first end portion of the magnetic layer and the second end portion of the first via portion can be brought close to each other, the inductor can be miniaturized. By bringing the first end portion of the magnetic layer and the second end portion of the first via portion close to each other, the volume of the magnetic layer can be increased, so the efficiency of obtaining inductance can be improved.

According to a twenty-third aspect, in the inductor component according to any one of the first to twenty-second aspects, the magnetic layer is provided along a first imaginary plane that intersects the first direction, the first inductor wire is spaced apart from the first imaginary plane in the first direction and is provided along a second imaginary plane that is parallel to the first imaginary plane, and a roughness of a planar portion of the magnetic layer located on the first imaginary plane is greater than or equal to 3 nm and less than or equal to 10 nm (i.e., from 3 nm to 10 nm).

With the inductor component according to the twenty-third aspect, it is possible to improve the efficiency of obtaining inductance while ensuring the adhesion of the magnetic layer. For example, when the roughness of the planar portion of the magnetic layer is less than 3 nm, the contact area of the magnetic layer reduces, with the result that the adhesion decreases. When the roughness of the planar portion of the magnetic layer is greater than 10 nm, the crystal structure of magnetic material included in the magnetic layer becomes random, and the uniaxial magnetic anisotropy of the magnetic layer collapses, so there is a possibility that the efficiency of obtaining inductance cannot be improved.

Hereinafter, embodiments of the present disclosure will be described with reference to the drawings. The following description does not limit the present disclosure and is merely illustrative in nature. Various modifications may be made as needed without departing from the spirit of the present disclosure. The drawings are schematic, and the dimensional ratios and the like may differ from those of the actual structure.

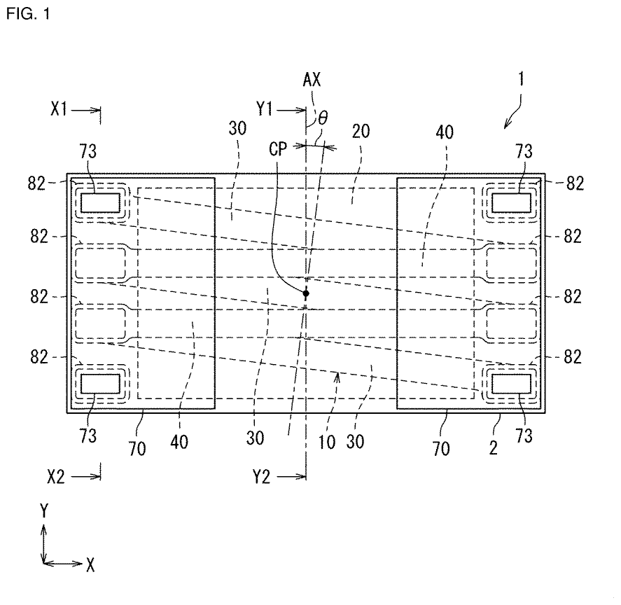

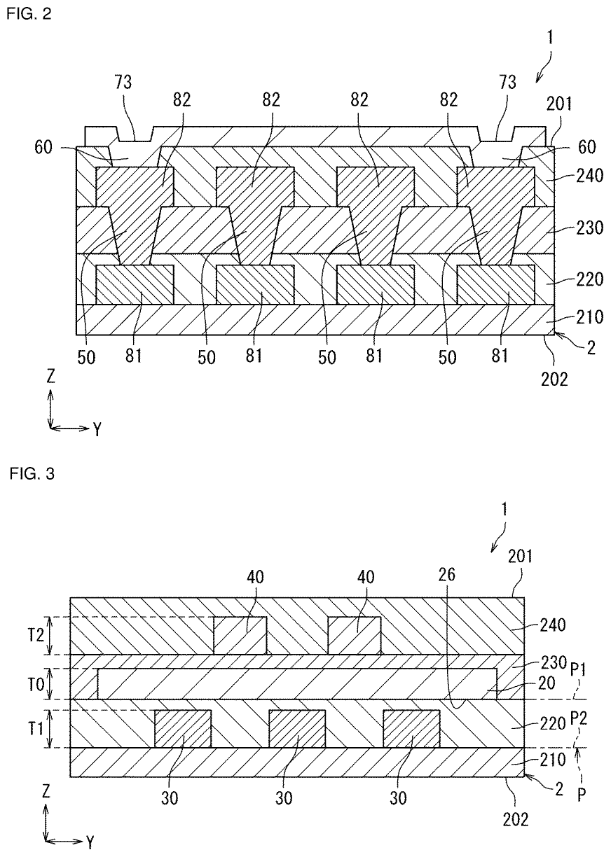

As shown in FIG. 1, an inductor component 1 according to an embodiment of the present disclosure includes an inductor element 10. The inductor element 10 includes a magnetic layer 20, first inductor wires 30, second inductor wires 40, and first via portions 50 (see FIG. 2).

As shown in FIGS. 1 to 3, in the present embodiment, the inductor component 1 further includes an element body 2, second via portions 60, external terminals 70, and pad portions 81 and 82. The inductor element 10, the second via portions 60, and the pad portions 81 and 82 are located within the element body 2, and the external terminals 70 are located outside the element body 2. The pad portions 81 and 82 may constitute parts of the first inductor wires 30 and the second inductor wires 40, respectively, or may be configured separately from the first inductor wires 30 and the second inductor wires 40.

As an example, the element body 2 has a substantially rectangular parallelepiped shape. The height direction of the element body 2 is defined as a first direction (for example, a Z direction), the short-side direction of the element body 2 when viewed along the first direction Z is defined as a second direction (for example, a Y direction), and the long-side direction of the element body 2 when viewed along the first direction Z is defined as a third direction (for example, an X direction). As shown in FIGS. 2 and 3, the element body 2 has a first main surface 201 and a second main surface 202 respectively located at opposite ends in the first direction Z.

The element body 2 includes four electrically insulating layers 210, 220, 230, and 240 sequentially laminated along the first direction Z. The electrically insulating layer 220 is an example of a first electrically insulating layer and covers the first inductor wires 30 and the pad portions 81. The electrically insulating layer 230 covers the magnetic layer 20. The electrically insulating layer 240 covers the second inductor wires 40 and the pad portions 82. The first main surface 201 is constituted by the outer surface of the electrically insulating layer 240 in the first direction Z, and the second main surface 202 is constituted by the outer surface of the electrically insulating layer 210 in the first direction Z. The electrically insulating layer 210 is an example of a second electrically insulating layer located farther from the magnetic layer 20 in the first direction Z than the electrically insulating layer 220 and having a lower coefficient of linear expansion than the electrically insulating layer 220.

Each of the electrically insulating layers 210, 220, 230, and 240 includes epoxy, polyimide, phenolic, or a combination of these materials. The electrically insulating layer 210 may include an electrical insulation filler or may include an inorganic electrical insulator, such as SiO₂ and TaO.

As an example, the inductor element 10 includes three first inductor wires 30, two second inductor wires 40, and six first via portions 50. The first inductor wires 30, the second inductor wires 40, and the first via portions 50 constitute at least part of a so-called helical inductor (coil) wound around an axis AX extending along the second direction Y. The helical shape refers to a shape in which the total number of turns of a coil is greater than one; however, the number of turns of the coil in a cross section orthogonal to the axis AX is less than one. “One turn or more” refers to a state in which the wire of the coil has radially adjacent portions in a cross section orthogonal to the axis AX. “Less than one turn” refers to a state in which the wire of the coil does not have radially adjacent portions in a cross section orthogonal to the axis AX.

The magnetic layer 20 has uniaxial magnetic anisotropy. In the present embodiment, the magnetic layer 20 has a rectangular shape when viewed along the first direction Z and is located inside the outer periphery of the inductor component 1. The term “rectangular shape” includes a substantially rectangular shape. The outer periphery of the inductor component 1 is, for example, the outer periphery of the element body 2. Eight pad portions 81 and 82 are located on each side of the magnetic layer 20 in the long-side direction of the magnetic layer 20. The pad portions 81 are located on the same side as the first inductor wires 30 relative to the magnetic layer 20, and the pad portions 82 are located on the same side as the second inductor wires 40 relative to the magnetic layer 20.

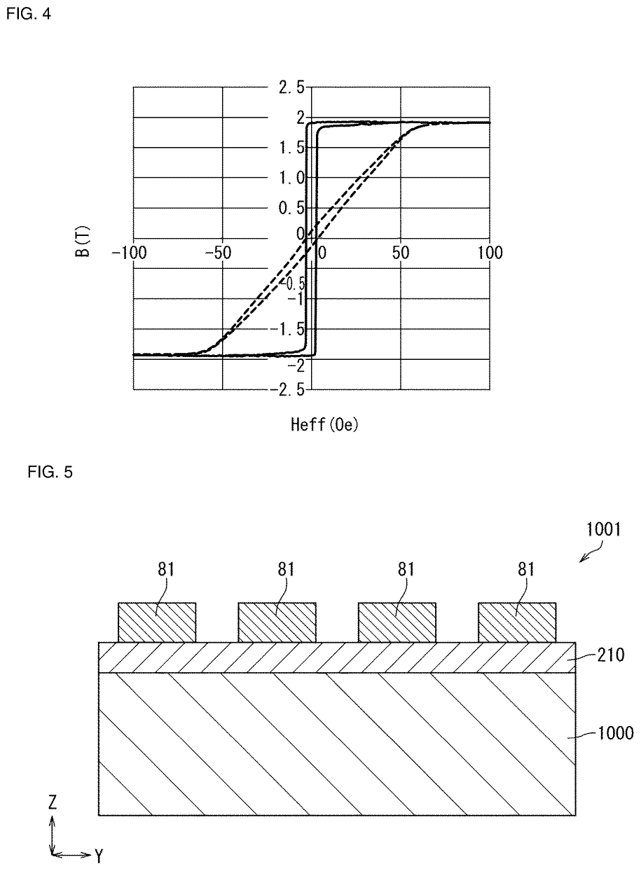

An example of the B-H curve of the magnetic layer 20 is shown in FIG. 4. In FIG. 4, the easy axis is represented by a solid line, and the hard axis is represented by a dashed line. As a method of measuring the hard-axis direction and easy-axis direction of uniaxial magnetic anisotropy, for example, there is a method in which a B-H curve of the magnetic layer 20 is measured using a vibrating sample magnetometer (VSM). In this method, B-H curves are measured with the sample rotated by 90 degrees, and the direction corresponding to the steeper B-H curve is taken as the easy axis, and the direction corresponding to the flatter B-H curve is taken as the hard axis. To eliminate the influence of shape anisotropy, an O-shaped or square-shaped sample is preferably used; however, samples having other shapes may also be used.

The magnetic layer 20 is configured such that the absolute value of the angle θ (see FIG. 1) formed between the hard axis or easy axis and the axis AX is larger than or equal to zero degrees and smaller than 10 degrees (i.e., from zero degrees to smaller than 10 degrees) (for example, such that the hard axis or easy axis and the axis AX are substantially parallel to each other). For example, it is assumed that the easy axis extends along the short-side direction (that is, the second direction Y) of the magnetic layer 20 and the hard axis extends along the long-side direction (that is, the third direction X) of the magnetic layer 20. In this case, the absolute value of the angle formed between the easy axis of the magnetic layer 20 and the axis AX is larger than or equal to zero degrees and smaller than 10 degrees (i.e., from zero degrees to smaller than 10 degrees). For example, it is assumed that the easy axis extends along the long-side direction (that is, the third direction X) of the magnetic layer 20 and the hard axis extends along the short-side direction (that is, the second direction Y) of the magnetic layer 20. In this case, the absolute value of the angle formed between the hard axis of the magnetic layer 20 and the axis AX is larger than or equal to zero degrees and smaller than 10 degrees (i.e., from zero degrees to smaller than 10 degrees).

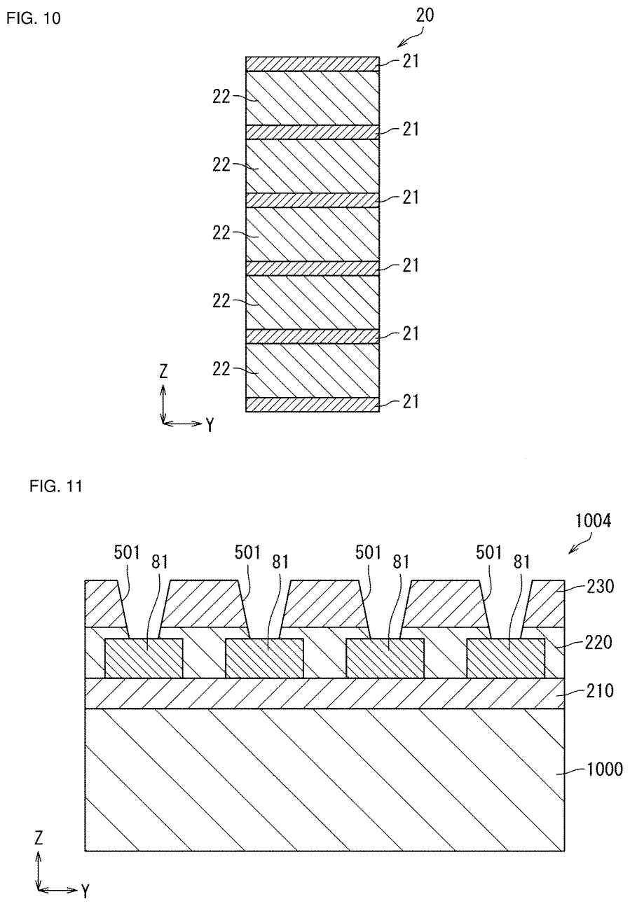

The magnetic layer 20 includes inorganic electrically insulating layers 21 and inorganic magnetic layers 22 laminated along the first direction Z (see FIG. 10). As an example, the magnetic layer 20 is composed of six inorganic electrically insulating layers 21 and five inorganic magnetic layers 22. The inorganic electrically insulating layers 21 are respectively located at opposite ends of the magnetic layer 20 in the first direction Z. Each of the inorganic electrically insulating layers 21 includes, for example, TaO or SiO₂. The inorganic magnetic layer 22 includes, for example, Co—Zr—Ta (CZT) or FeNi alloy. When the thickness of the inorganic magnetic layer 22 is increased, eddy currents may occur within the magnetic layer 20. For this reason, the inorganic magnetic layer 22 is configured to be thinner than the skin depth derived from the circuit operating frequency (for example, the switching frequency in the case of a DC-DC converter).

As shown in FIG. 3, the magnetic layer 20 is configured such that the thickness T0, which is a dimension in the first direction Z, is less than the thickness T1 of the first inductor wire 30 and the thickness T2 of the second inductor wire 40.

Each of the first inductor wires 30 is located on one side of the magnetic layer 20 in the first direction Z and extends along an imaginary plane P that intersects the first direction Z. Each of the second inductor wires 40 is located on the other side of the magnetic layer 20 in the first direction Z. In the present embodiment, the imaginary plane P is located at the boundary between the electrically insulating layers 210 and 220 of the element body 2.

As shown in FIG. 1, each of the first inductor wires 30 connects one of the four pad portions 81 located on one side of the magnetic layer 20 in the third direction X to one of the four pad portions 81 located on the other side of the magnetic layer 20 in the third direction X, when viewed along the first direction Z and a direction from the second inductor wires 40 to the first inductor wires 30. Each of the first inductor wires 30 connects two pad portions 81 at different positions in the second direction Y, and is inclined relative to the axis AX. Three first inductor wires 30 extend substantially parallel to one another.

As shown in FIG. 1, each of the second inductor wires 40 connects one of the four pad portions 82 located on one side of the magnetic layer 20 in the third direction X to twenty one of the four pad portions 82 located on the other side of the magnetic layer 20 in the third direction X, when viewed along the first direction Z and a direction from the second inductor wires 40 to the first inductor wires 30. Each of the second inductor wires 40 connects two pad portions 82 that are substantially in the same position in the second direction Y and is substantially orthogonal to the axis AX. Two second inductor wires 40 extend substantially parallel to each other.

The first inductor wires 30 and the second inductor wires 40 include, for example, a good conductor material, such as copper, silver, gold, and alloys of these materials. The first inductor wires 30 and the second inductor wires 40 may be a metal film formed by, for example, plating, vapor deposition, sputtering, or the like, or may be a metal sintered body formed by applying a conductor paste and sintering the conductor paste. Each of the first inductor wires 30 and the second inductor wires 40 may have a multilayer structure in which a plurality of metal layers is laminated. Each of the first inductor wires 30 and the second inductor wires 40 is configured not to be thicker than the thickness of the magnetic layer 20. With this configuration, an inductor component with low direct-current resistance and high efficiency of obtaining inductance can be realized.

Each of the first via portions 50 electrically connects the first inductor wire 30 and the second inductor wire 40. In the present embodiment, as shown in FIG. 2, the first via portion 50 extends along the first direction Z and connects the pair of pad portions 81 and 82 that are at substantially the same position in the first direction Z.

The second via portion 60 electrically connects at least one of the first inductor wire 30 and the second inductor wire 40 to the external terminal 70. In the present embodiment, as shown in FIG. 2, the second via portions 60 extend along the first direction Z and connect the pad portions 82 located at opposite ends in the second direction Y to the external terminal 70. Through this connection, the second inductor wire 40 is electrically connected to the external terminal 70.

The external terminal 70 is located on the first main surface 201 of the element body 2. In the present embodiment, the inductor component 1 includes two external terminals 70. Each of the external terminals 70 includes a base layer and a plating layer covering the base layer, and is disposed so as to cover four pad portions 82 that are located on the same side in the third direction X relative to the magnetic layer 20 when viewed along the first direction Z. As shown in FIG. 2, each of the external terminals 70 has four recessed portions 73 corresponding to the four pad portions 82. Each of the recessed portions 73 is provided at a position overlapping the pad portion 82 when viewed along the first direction Z, and is recessed toward the magnetic layer 20.

The first via portion 50, the second via portion 60, and the base layer of the external terminal 70 include, for example, an electrically conductive material, such as Ni and Sn. Each of the first via portions 50 and the second via portions 60 may be composed of a single layer of an electrically conductive material or may be composed of a plurality of layers of an electrically conductive material. The external terminal 70 may be composed of a single layer of an electrically conductive material.

As shown in FIG. 1, each of the components that constitute the inductor component 1 is symmetrically disposed relative to the central point CP of the element body 2 on the axis AX when viewed along the first direction Z.

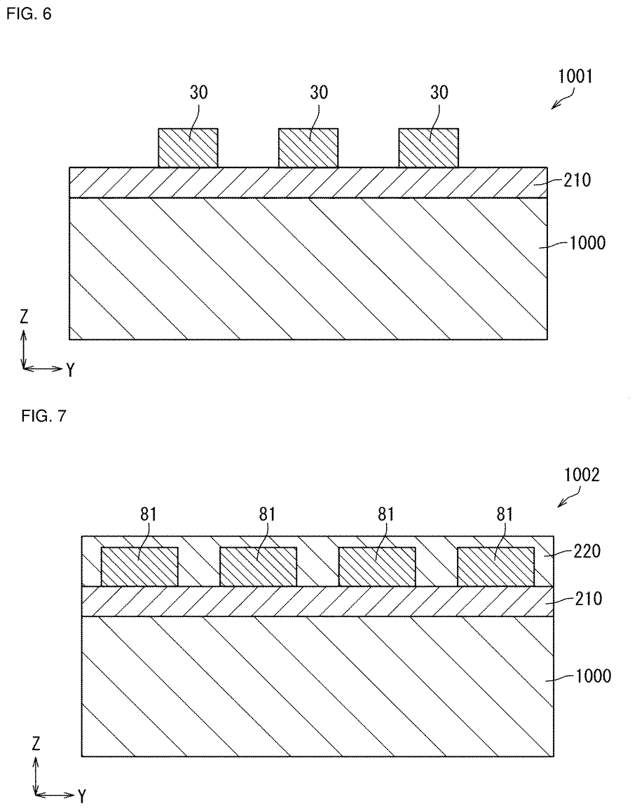

An example of a manufacturing method for the inductor component 1 will be described with reference to FIGS. 2, 3, and 5 to 16. FIGS. 5, 7, 11, 13, and 15 are drawings corresponding to the cross section taken along the line X1-X2 in FIG. 1, and FIGS. 6, 8 to 10, 12, 14, and 16 are drawings corresponding to the cross section taken along the line Y1-Y2 in FIG. 1.

As shown in FIGS. 5 and 6, the electrically insulating layer 210 is formed on a substrate 1000, and the first inductor wires 30 and the pad portions 81 are formed on the electrically insulating layer 210, to form a first multilayer body 1001. For example, a substrate that has high electrical insulation properties and that can suppress eddy currents (such as a semiconductor substrate, a glass substrate, an organic resin substrate, and ceramic) is used as the substrate 1000. The electrically insulating layer 210 is formed, for example, by a step in which an organic resin is applied on the substrate 1000 and is cured. The first inductor wires 30 and the pad portions 81 are formed, for example, by seed formation (sputtered Ti/Cu), resist coating, development, exposure, electrolytic plating, resist stripping, and seed etching.

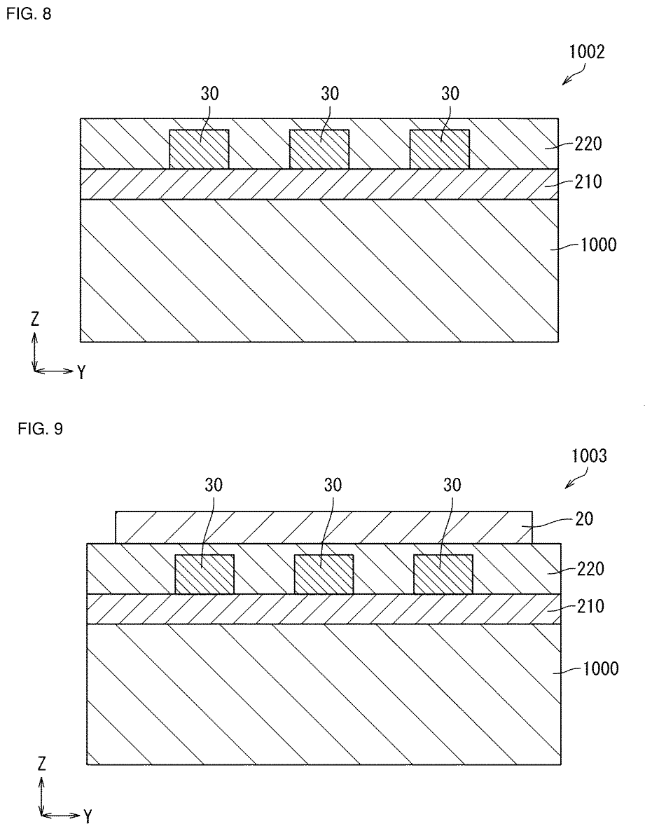

As shown in FIGS. 7 and 8, the electrically insulating layer 220 that covers the first inductor wires 30 and the pad portions 81 is formed on the electrically insulating layer 210 of the formed first multilayer body 1001, to form a second multilayer body 1002. The electrically insulating layer 220 is formed, for example, by a step in which an organic resin is applied on the electrically insulating layer 210 and cured.

As shown in FIG. 9, the magnetic layer 20 is formed on the electrically insulating layer 220 of the formed second multilayer body 1002, to form a third multilayer body 1003. As shown in FIG. 10, the magnetic layer 20 includes the plurality of inorganic electrically insulating layers 21 and the plurality of inorganic magnetic layers 22 that are alternately laminated along the first direction Z. The magnetic layer 20 is formed, for example, by a step in which sputtering of an insulating material and sputtering of a magnetic material are repeated. By forming the magnetic layer 20 using a sputtering method in a magnetic field, the atomic arrangement is formed at a desired position, and the direction of the applied magnetic field becomes the easy-axis direction. After the magnetic layer 20 is formed, the magnetic layer 20 can be formed at a desired position through resist coating, exposure, development, etching, and resist stripping.

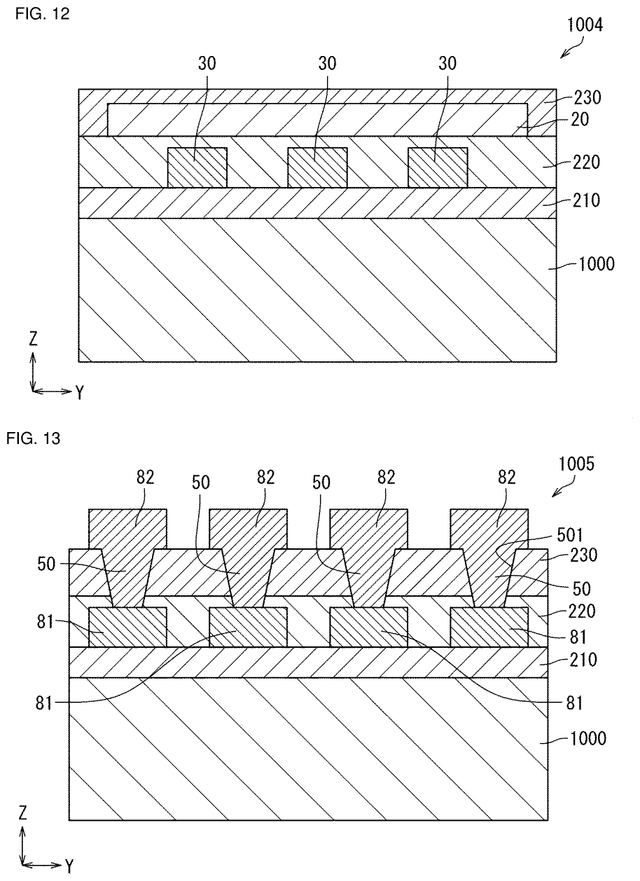

As shown in FIGS. 11 and 12, the electrically insulating layer 230 is formed on the electrically insulating layer 220 of the formed third multilayer body 1003, and via openings 501 are formed in the electrically insulating layer 230, to form a fourth multilayer body 1004. The electrically insulating layer 230 is formed, for example, by a step in which an organic resin is applied on the electrically insulating layer 220 and cured. The via openings 501 are, for example, formed using a laser so as to penetrate the electrically insulating layer 230 along the first direction Z to the electrically insulating layer 220 and to expose the pad portions 81 from the bottom surface.

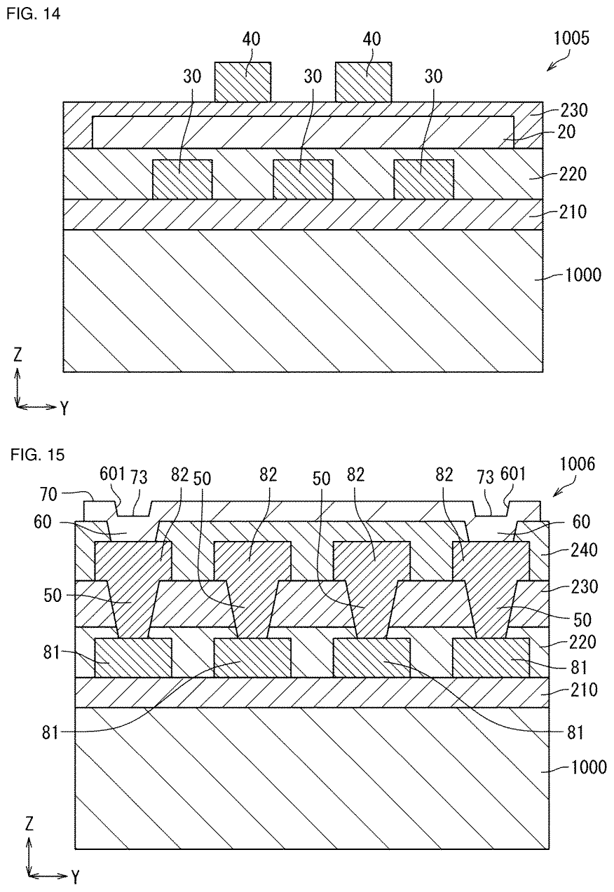

As shown in FIGS. 13 and 14, the first via portions 50 are formed in the via openings 501 of the formed fourth multilayer body 1004, the pad portions 82 are formed on the first via portions 50 and the electrically insulating layer 230, and the second inductor wires 40 are formed on the electrically insulating layer 230, to form a fifth multilayer body 1005. The second inductor wires 40 and the pad portions 82 are formed, for example, by seed formation (sputtered Ti/Cu), resist coating, development, exposure, electrolytic plating, resist stripping, and seed etching.

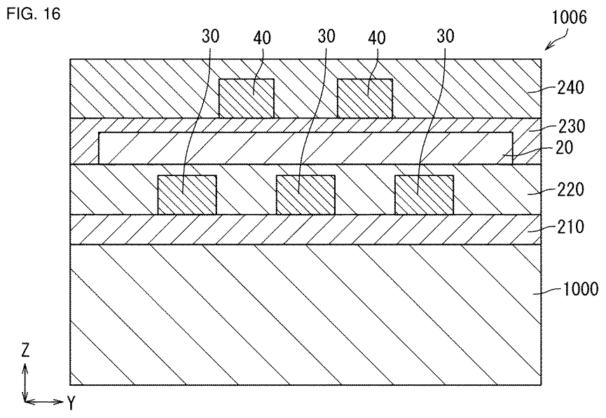

As shown in FIGS. 15 and 16, the electrically insulating layer 240 covering the second inductor wires 40 and the pad portions 82 is formed on the electrically insulating layer 230 of the formed fifth multilayer body 1005, via openings 601 are formed in the electrically insulating layer 240, and the external terminals 70 are formed, to form a sixth multilayer body 1006. The electrically insulating layer 240 is formed, for example, by a process in which an organic resin is applied on the electrically insulating layer 230 and cured. The via openings 601 are, for example, formed using a laser so as to extend along the first direction Z and to expose the pad portions 82 from the bottom surface. The external terminals 70 are formed, for example, by electroless Ni/Au plating. By performing Cu-filled plating first before the electroless Ni/Au plating, the external terminals 70 without the recessed portions 73 can be formed.

The inductor component 1 shown in FIGS. 2 and 3 is manufactured by removing the substrate 1000 from the formed sixth multilayer body 1006 and singulating the multilayer body. The substrate 1000 is removed, for example, by polishing or peeling.

The inductor component 1 can exhibit the following advantageous effects.

The inductor component 1 includes at least one inductor element 10. The inductor element 10 includes the magnetic layer 20 having uniaxial magnetic anisotropy, the first inductor wires 30, the second inductor wires 40, and the first via portions 50. The first inductor wires 30 are located on one side of the magnetic layer 20 in the first direction and extend along an imaginary plane that intersects the first direction. The second inductor wires 40 are located on the other side of the magnetic layer 20 in the first direction. Each of the first via portions 50 electrically connects the first inductor wire 30 and the second inductor wire 40. The first inductor wires 30, the second inductor wires 40, and the first via portions 50 constitute at least part of the inductor wound around the axis AX extending along a second direction that intersects the first direction. The absolute value of the angle θ formed between the hard axis or easy axis of the magnetic layer 20 and the axis AX is larger than or equal to zero degrees and smaller than 10 degrees (i.e., from zero degrees to smaller than 10 degrees). With this configuration, since most of the magnetic flux is oriented toward the anisotropy axis, the efficiency of obtaining inductance can be improved, and the direct-current superposition characteristics can be improved. Since the first inductor wires 30 extending along the imaginary plane, the second inductor wires 40, and the first via portions 50 constitute part of the inductor, the inductor component 1 can be easily miniaturized (for example, reduced in thickness).

In the configuration in which the absolute value of the angle θ formed between the easy axis and the axis AX is larger than or equal to zero degrees and smaller than 10 degrees (i.e., from zero degrees to smaller than 10 degrees), most of the magnetic flux passes through the easy axis, so the efficiency of obtaining inductance with the inductor component 1 can be improved.

In the configuration in which the absolute value of the angle θ formed between the hard axis and the axis AX is larger than or equal to zero degrees and smaller than 10 degrees (i.e., from zero degrees to smaller than 10 degrees), most of the magnetic flux passes through the hard axis, so the direct-current superposition characteristics of the inductor component 1 can be improved, and iron loss can be reduced.

In a case where the magnetic layer 20 has a rectangular shape when viewed along the first direction, when the influence of shape magnetic anisotropy is considered, the anisotropy axis can be easily controlled by setting the long-side direction of the magnetic layer 20 as the easy axis.

The magnetic layer 20 includes inorganic electrically insulating layers 21 and inorganic magnetic layers 22 laminated along the first direction. The thickness T0, which is a dimension in the first direction, of the magnetic layer 20 is less than the thickness T1 of the first inductor wire 30 and the thickness T2 of the second inductor wire 40. With this configuration, eddy currents reduce, so the quality factor of the inductor can be increased.

The inorganic electrically insulating layers 21 are located at opposite ends of the magnetic layer 20 in the first direction. With this configuration, electrical insulation between the inductor component 1 and peripheral members such as wires can be reliably ensured.

The inductor component 1 includes the external terminal 70 having the recessed portion 73 that is recessed toward the magnetic layer 20. With this configuration, the connection area of the external terminal 70 is increased due to the recessed portion 73, so the adhesion strength of the external terminal 70 can be improved.

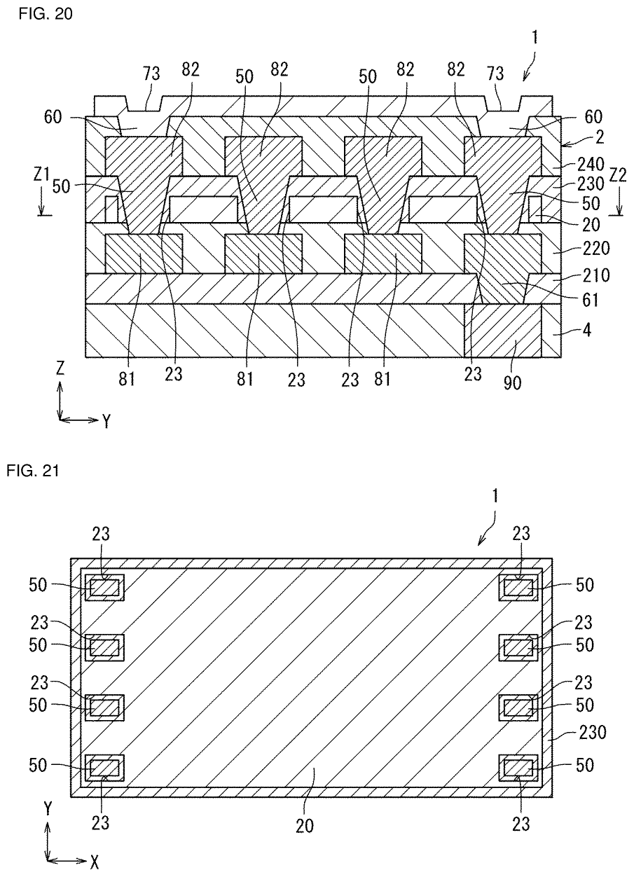

The inductor component 1 includes the electrically insulating layer 220 covering the first inductor wires 30, and the electrically insulating layer 210 located farther from the magnetic layer 20 in the first direction than the electrically insulating layer 220 and having a lower coefficient of linear expansion than the electrically insulating layer 220. With this configuration, for example, by connecting the substrate 4 with the electrically insulating layer 210 interposed therebetween (see FIG. 20), the strength of the substrate 4 can be improved.

The magnetic layer 20 is located inside the outer periphery of the inductor component 1 when viewed along the first direction. With this configuration, for example, damage to the magnetic layer 20 due to mechanical stress as a result of cutting during a singulation process can be reduced. When the magnetic layer 20 is elongated by mechanical stress during cutting, leakage may occur between the laminated magnetic layers 20, which may increase iron loss.

The inductor component 1 can be configured as follows.

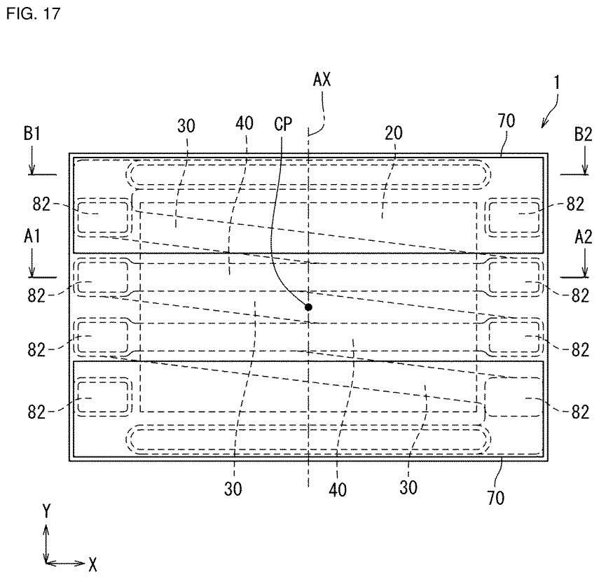

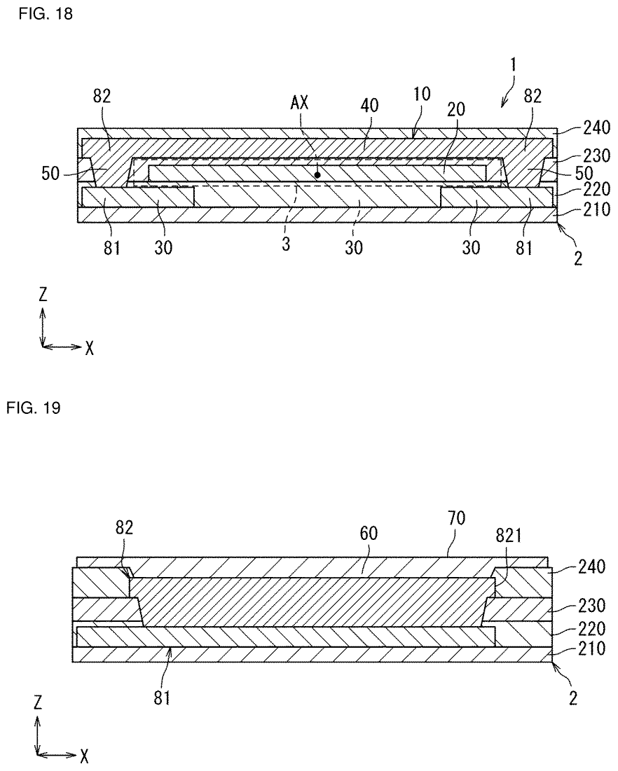

As shown in FIGS. 17 to 19, the inductor component 1 may include the first via portion 50 that at least partially overlaps the magnetic layer 20 when viewed along the axis AX. In this case, since the magnetic flux can be blocked by the first via portion 50, noise leakage to the surroundings of the inductor component 1 can be suppressed. As shown in FIG. 18, a portion surrounded by the first inductor wire 30, the second inductor wire 40, and the first via portion 50 constitutes a core portion 3.

In the inductor component 1 shown in FIGS. 17 to 19, when viewed along the first direction Z, one of the two external terminals 70 is disposed so as to cover two pad portions 82 located at one end in the second direction Y, and the other of the two external terminals 70 is disposed so as to cover two pad portions 82 located at the other end in the second direction Y. The pad portions 81 and 82 located at opposite ends in the second direction Y have portions 811 and 821 that extend along the third direction X, as shown in FIG. 19. The first via portion 50, which connects the pad portions 81 and 82 located at each end in the second direction Y, is configured to connect the portions 811 and 821. As shown in FIGS. 18 and 19, the portions 811 and 821 are configured to overlap at least more than half of the magnetic layer 20 when viewed along the axis AX. In the inductor component 1 shown in FIGS. 17 to 19, since at least more than half of the magnetic layer 20 overlaps the first via portion 50 when viewed along the axis AX, noise leakage to the surroundings of the inductor component 1 can be more reliably suppressed. In the inductor component 1 shown in FIGS. 17 to 19, the recessed portion 73 is not formed on the external terminal 70.

As shown in FIGS. 20 and 21, the inductor component 1 may include the first via portions 50 that penetrate the magnetic layer 20 along the first direction Z. In other words, the magnetic layer 20 can have through-holes 23 that can accommodate the first via portions 50. In this case, since the magnetic layer 20 can be maximized along the imaginary plane P, it is possible to suppress leakage flux while enhancing the efficiency of obtaining inductance with the inductor component 1. In the inductor component 1 shown in FIGS. 20 and 21, the magnetic layer 20 has the plurality of through-holes 23 corresponding to all the respective first via portions 50. Each of the through-holes 23 is configured to be able to accommodate the first via portion 50 in a state where a clearance is provided between the through-hole 23 and the first via portion 50. The shape of each of the through-holes 23 is not limited to a rectangular shape, and may also be a circular shape or another polygonal shape.

The inductor component 1 shown in FIGS. 20 and 21 is mounted on a substrate 4. In other words, the substrate 4 is connected to the inductor component 1 with the electrically insulating layer 210 interposed therebetween. Examples of the substrate 4 include a high-resistance silicon substrate, a glass substrate, and a ceramic substrate. A terminal 90 electrically connectable to an external circuit is formed within the substrate 4. The inductor component 1 shown in FIGS. 20 and 21 includes a vertical wire 61 that penetrates the electrically insulating layer 210 along the first direction Z and that connects one pad portion 81 and the terminal 90. In other words, the inductor component 1 shown in FIGS. 20 and 21 is configured to be electrically connectable to an external circuit with the vertical wire 61 and the terminal 90 interposed therebetween. The vertical wire 61 improves the flexibility of the mounting location for the inductor component 1.

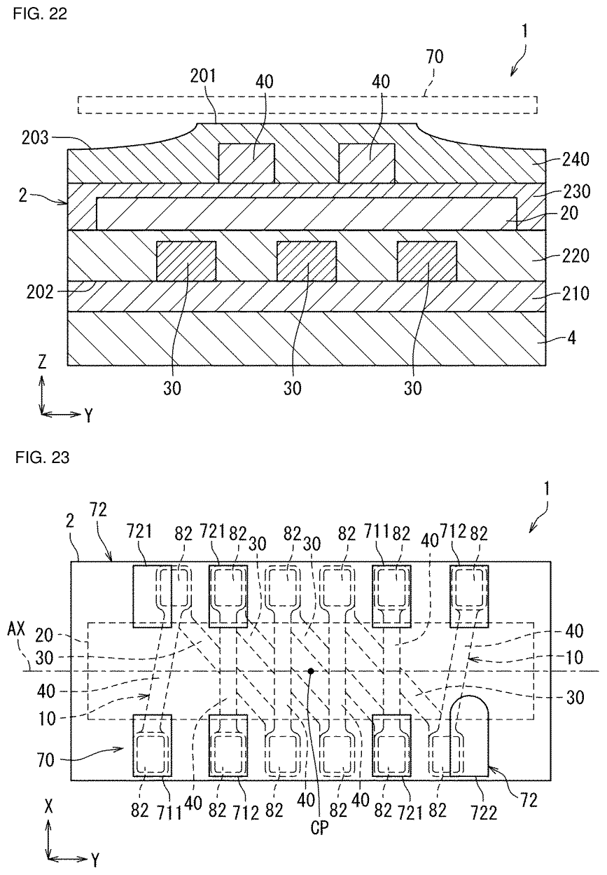

As shown in FIG. 22, the inductor component 1 may include the element body 2 in which the surface roughness of the first main surface 201 and the surface roughness of the second main surface 202 are different from each other. In this case, by performing resin molding on the main surface having a greater surface roughness, the adhesion to the molding material can be improved. In the inductor component 1 shown in FIG. 22, the external terminal 70 is located on the first main surface 201, and the element body 2 has recessed portions 203 that are recessed from the first main surface 201 toward the magnetic layer 20 in the first direction Z. In the inductor component 1 shown in FIG. 22, the element body 2 has two recessed portions 203. Alternatively, the element body 2 may have one recessed portion 203 or may have three or more recessed portions 203. As an example, the element body 2 is configured such that the first main surface 201 is positioned closer to the magnetic layer 20 than the external terminal 70. In the inductor component 1 shown in FIG. 22, since the external terminal 70 is located farthest from the magnetic layer 20, the inductor component 1 can be easily mounted on the substrate 4 or the like.

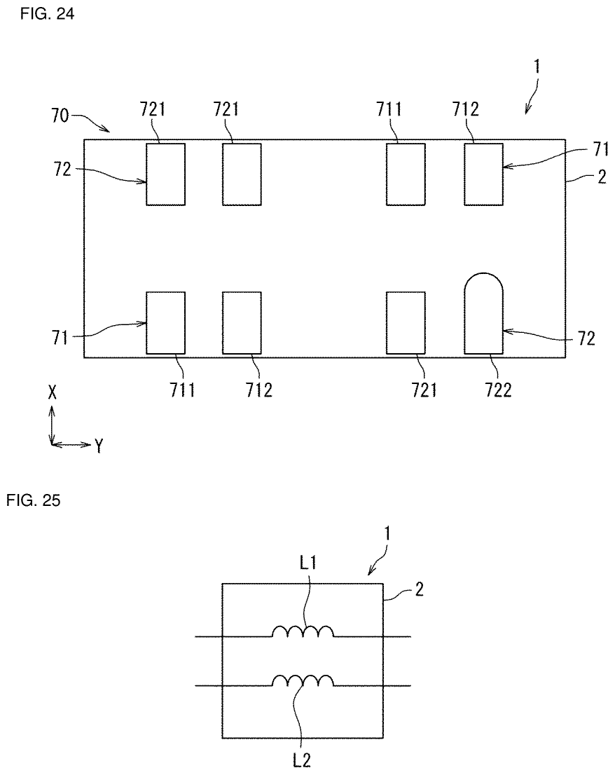

As shown in FIGS. 23 to 25, in the inductor component 1, the external terminals 70 may include first external terminals 71 and second external terminals 72. The second external terminals 72 are dummy terminals that are not electrically connected to either the first inductor wire 30 or the second inductor wire 40. The first external terminal 71 is electrically connected to at least one of the first inductor wires 30 and the second inductor wires 40. In the inductor component 1 shown in FIG. 23, the magnetic layer 20 is positioned such that the second direction Y is the long-side direction and the third direction X is the short-side direction. Two first external terminals 71 and two second external terminals 72 are provided on each side of the axis AX. In the third direction X, one first external terminal 71 and one second external terminal 72 face each other. In the inductor component 1 shown in FIG. 23, the second external terminals 72 include three terminals 721 having the same shape as the first external terminal 71, and one terminal 722 having a different shape from the first external terminal 71. The terminal 722 is configured to be usable as a “direction mark” indicating the mounting direction of the inductor component 1. With this configuration, the mounting strength of the inductor component 1 can be improved. By making the shape of the second external terminal 72 different from the shape of the first external terminal 71, the mounting direction of the inductor component 1 can be easily recognized.

The inductor component 1 shown in FIGS. 23 to 25 includes a plurality of the inductor elements 10. As an example, the inductor component 1 shown in FIGS. 23 to 25 includes two inductor elements 10. Each inductor element 10 constitutes at least part of one of the two inductors L1 and L2. In the inductor component 1 shown in FIGS. 23 to 25, among the first external terminals 71, a pair of terminals 711 is located at opposite ends of the inductor L1, and a pair of terminals 712 is located at opposite ends of the inductor L2. In this way, when the single inductor component 1 includes the plurality of inductor elements 10, the mounting area of the inductor component 1 can be reduced.

The spacing between the first inductor wires 30 or the second inductor wires 40 of the adjacent inductor elements 10 may vary along the first inductor wires or the second inductor wires 40. With this configuration, the flexibility of the design regarding the extended position of the external terminal 70 can be improved. The coupling coefficient can be adjusted. For example, in the inductor component 1 shown in FIGS. 23 to 25, the spacing between the second inductor wires 40 located at opposite ends in the second direction Y among the second inductor wires 40 of the adjacent inductor elements 10 varies along a direction in which the second inductor wires 40 extend (for example, the third direction X). In other words, two adjacent second inductor wires 40 are not parallel to each other. The external terminals 70 of the inductor component 1 shown in FIGS. 23 to 25 are asymmetrically disposed relative to the central point CP of the element body 2 when viewed along the first direction Z.

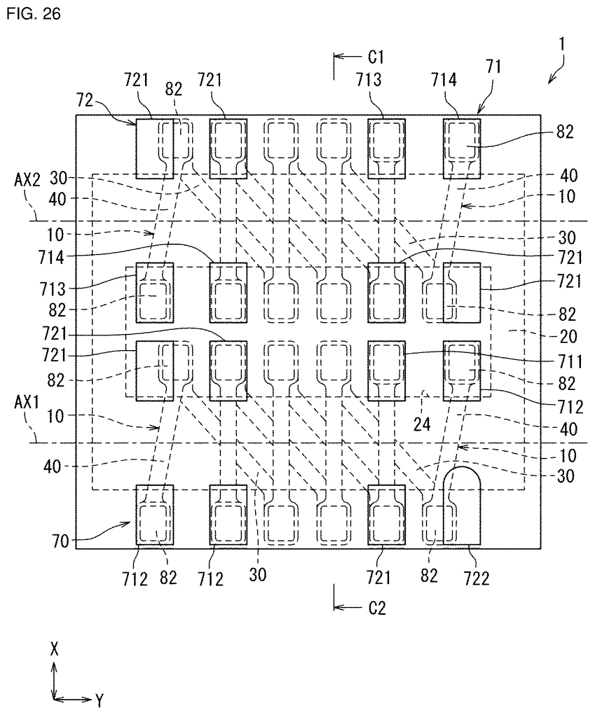

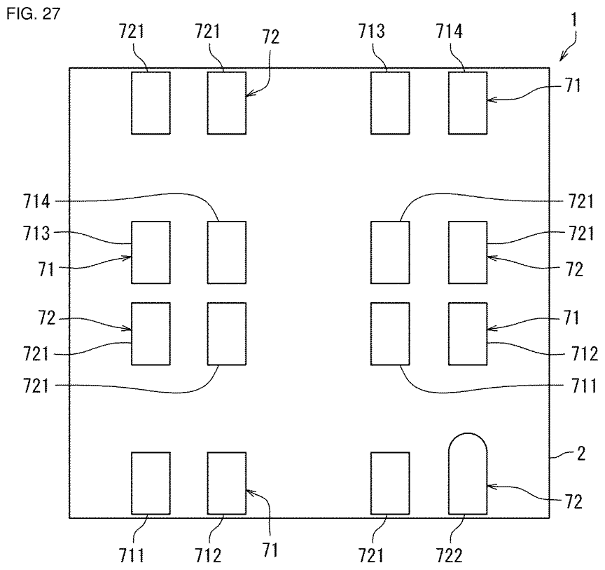

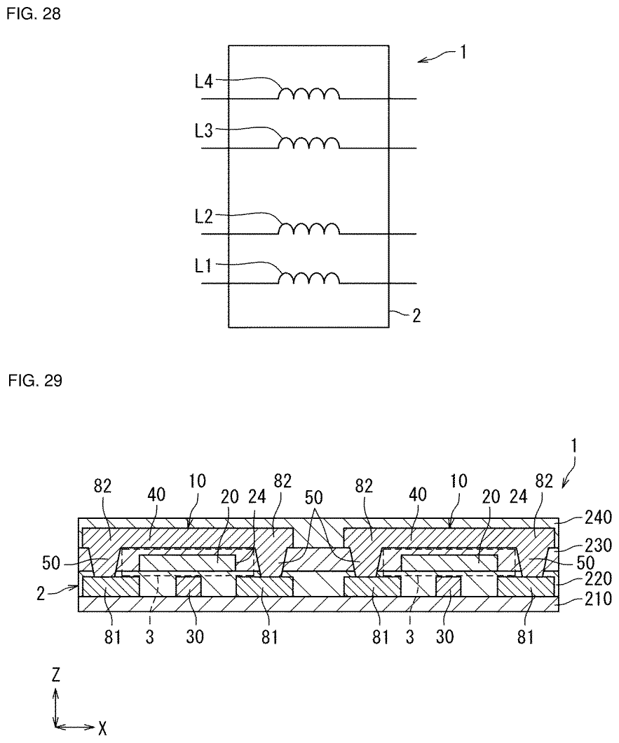

As shown in FIGS. 26 to 29, the inductor component 1 may include 2N (where N is a natural number) inductor elements 10. In the inductor component 1 shown in FIGS. 26 to 29, the inductor component 1 includes four inductor elements 10. Each inductor element 10 constitutes at least part of one of four inductors L1 to L4. In the inductor component 1 shown in FIGS. 26 to 29, among the first external terminals 71, the pair of terminals 711 is located at opposite ends of the inductor L1, the pair of terminals 712 is located at opposite ends of the inductor L2, a pair of terminals 713 is located at opposite ends of an inductor L3, and a pair of terminals 714 is located at opposite ends of an inductor L4. In the inductor component 1 shown in FIGS. 26 to 29, the inductors L1 and L2 are wound around an axis AX1, and the inductors L3 and L4 are wound around an axis AX2. The axes AX1 and AX2 extend parallel (including substantially parallel) with a spacing in the third direction X. In this way, by disposing N (=2) inductors L1 and L2 around one axis AX1 and disposing N (=2) inductors L3 and L4 around the other axis AX2, the symmetry of the inductor component 1 is ensured, so the stress within the elements can be suppressed. For example, when two inductors are disposed around one axis AX1 and only one inductor is disposed around the other axis AX2, space for the magnetic layer 20 may be wasted. Therefore, when the inductor component 1 includes 2N (where N is a natural number) inductor elements 10, space for the magnetic layer can be effectively used.

In the inductor component 1 shown in FIGS. 26 to 29, as an example, the magnetic layer 20 has a through-hole 24 provided at a center of the magnetic layer 20 and extending along the first direction Z. The through-hole 24 is configured such that two first via portions 50 can be accommodated, as shown in FIG. 29. The magnetic layer 20 has a ring shape overall, and each of the inductors L1, L2, L3, and L4 is wound around one of the axes AX1 and AX2 extending along the long-side direction (for example, the second direction Y) of the magnetic layer 20. With this configuration, the inductor component 1 having small leakage flux can be realized.

In the inductor component 1 shown in FIGS. 26 to 29, as an example, the coupling coefficient of a first set of inductors (for example, the inductors L1 and L2) is configured to be greater than the coupling coefficient of a second set of inductors (for example, the inductors L3 and L4). Ripple can be suppressed by strengthening the coupling, and the efficiency of the DC-DC converter can be improved by combining a strongly coupled inductor with a weakly coupled inductor for a multi-phase configuration.

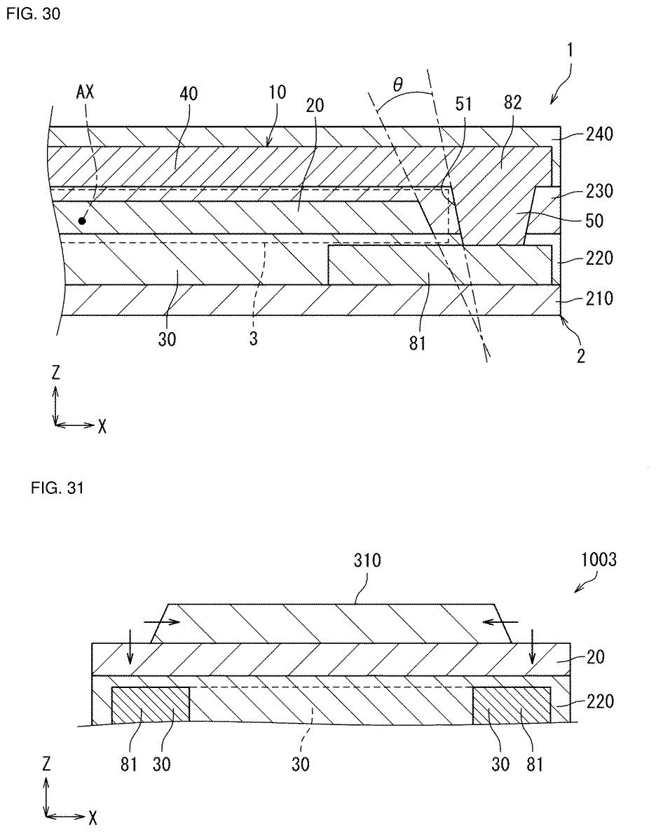

As shown in FIG. 30, the inductor component 1 may be configured such that the magnetic layer 20 has a first end portion 25 that faces the first via portion 50 in the third direction X, the first via portion 50 has a second end portion 51 that faces the magnetic layer 20 in the third direction X, and the first end portion 25 and the second end portion 51 are inclined in the same direction relative to the first direction Z. With this configuration, the first end portion 25 of the magnetic layer 20 and the second end portion 51 of the first via portion 50 can be brought close to each other, so the inductor can be miniaturized. By bringing the first end portion 25 of the magnetic layer 20 and the second end portion 51 of the first via portion 50 close to each other, the volume of the magnetic layer 20 can be increased, so the efficiency of obtaining inductance can be improved. The phrase “inclined in the same direction” means that, for example, when viewed in a cross section including the first direction Z and the third direction X, the angle θ0 formed between the extension of the first end portion 25 and the extension of the second end portion 51 is in a range larger than or equal to zero degrees and smaller than 45 degrees (i.e., from zero degrees to smaller than 45 degrees).

The magnetic layer 20 may have only one inclined end in the third direction X, or may have both inclined ends in the third direction X. It is assumed that opposite ends of the magnetic layer 20 in the third direction X are inclined (that is, the magnetic layer 20 has the first end portions 25 respectively at opposite ends in the third direction X). It is also assumed that the first inductor wire 30 and the second inductor wire 40 are laminated in this order. In this case, when viewed in a cross section including the first direction Z and the third direction X, the magnetic layer 20 has a trapezoidal shape in which one of opposite ends in the first direction Z closer to the first inductor wire 30 is the long side and the other end closer to the second inductor wire 40 is the short side, and the first via portion 50 has a trapezoidal shape in which the positions of the long side and short side are reversed as compared with the magnetic layer 20 (in other words, an inverted trapezoidal shape). When the first via portion 50 has an inverted trapezoidal shape relative to the magnetic layer 20, the seed adhesion improves. In this case, since the magnetic layer 20 has a trapezoidal shape, the distance between the magnetic layer 20 and the first via portion 50 is more easily maintained, so electrical insulation properties can be more easily ensured. The order in which the first inductor wire 30 and the second inductor wire 40 are laminated can be determined based on a direction in which a seed is present, the shapes of the first inductor wire 30 and the second inductor wire 40, or the like.

When the second end portion 51 of the first via portion 50 has a smaller inclination angle than the first end portion 25 of the magnetic layer 20, the first via portion 50 can be reduced in size, so the volume of the magnetic layer 20 can be increased. When the second end portion 51 of the first via portion 50 has a larger inclination angle than the first end portion 25 of the magnetic layer 20 and the first via portion 50 has an inverted trapezoidal shape, the seed adhesion can be improved. When the second end portion 51 of the first via portion 50 has a larger inclination angle than the first end portion 25 of the magnetic layer 20 and the first via portion 50 has a trapezoidal shape, the first via portion 50 serves as an anchor, so the adhesion strength between the first via portion 50 and the first inductor wire 30 can be enhanced. As an example, an angle relative to an imaginary straight line extending in the first direction Z is referred to as an inclination angle.

For example, when the etch rates of the inorganic electrically insulating layer 21 and the inorganic magnetic layer 22 are different, the first end portion 25 of the magnetic layer 20 may have a stepped shape. In this case, for example, an imaginary straight line connecting the edges of the inorganic magnetic layer 22 is calculated using the least-squares method. The calculated imaginary straight line is regarded as the first end portion 25, and the inclination angle of the first end portion 25 is calculated.

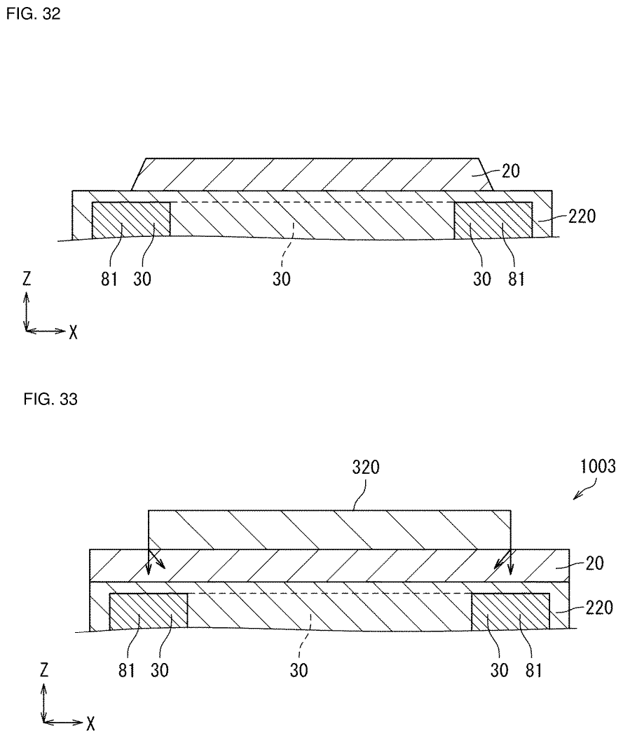

An example of a method of forming the trapezoidal magnetic layer 20 having the first end portions 25 at opposite ends in the third direction X (an example of a method of forming the inductor component 1 shown in FIG. 30) will be described with reference to FIGS. 31 and 32.

As shown in FIG. 31, a resist 310 having a tapered shape is formed on the magnetic layer 20 of the third multilayer body 1003. A tapered shape refers to a shape that tapers from the first inductor wire 30 toward the second inductor wire 40 along the first direction Z. When the resist 310 and the magnetic layer 20 are etched by dry etching, the resist 310 recedes while the magnetic layer 20 is etched in the direction indicated by the arrows in FIG. 31, with the result that the trapezoidal magnetic layer 20 shown in FIG. 32 is formed.

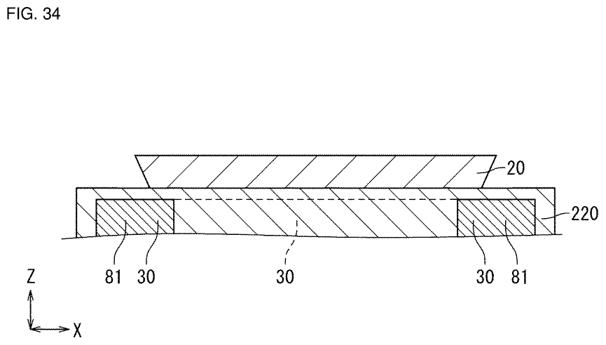

An example of a method of forming the inverted trapezoidal magnetic layer 20 having the first end portions 25 at opposite ends in the third direction X (an example of a method of forming the inductor component 1 in which the directions in which the first end portions 25 of the magnetic layer 20 are inclined are reversed from the directions in FIG. 30) will be described with reference to FIGS. 33 and 34. In this case, the first end portion 25 is inclined away from the first via portion 50 as the first end portion 25 extends from the second inductor wire 40 toward the first inductor wire 30 along the first direction Z.

As shown in FIG. 33, a resist 320 having a substantially rectangular cross-sectional shape is formed on the magnetic layer 20 of the third multilayer body 1003. When the resist 320 and the magnetic layer 20 are etched by wet etching, the magnetic layer 20 is etched in an oblique direction (indicated by arrows in FIG. 33) from portions where liquid replacement easily occurs, with the result that the inverted trapezoidal magnetic layer 20 shown in FIG. 34 is formed.

It is sufficient that the inductor component 1 includes at least one inductor element 10.

The inductor component 1 is not limited to the case where the inductor component 1 includes the external terminals 70 located on the first main surface 201 of the element body 2. Alternatively, the inductor component 1 may include the external terminals 70 located on the second main surface 202 of the element body 2, or may include the external terminals 70 located on both the first main surface 201 and the second main surface 202 of the element body 2.

The magnetic layer 20 is not limited to the case where the magnetic layer 20 includes the inorganic electrically insulating layers 21 and the inorganic magnetic layers 22 laminated along the first direction. For example, the magnetic layer 20 may be composed of a composite material of resin and magnetic filler. In this case, examples of the resin include epoxy, polyimide, acrylic, phenolic, and combinations of these materials. Examples of the magnetic filler include FeSiCr-based, FeNi-based, FeSi-based, pure Fe, and combinations of these materials.

The magnetic layer 20 may be provided along the first imaginary plane P1 (see FIG. 3). The first imaginary plane P1 is a plane (for example, an XY plane) that extends in a direction intersecting the height direction (for example, the first direction Z) of the element body 2 and that is located at the boundary between the electrically insulating layer 220 and the electrically insulating layer 230. In this case, the magnetic layer 20 has the planar portion 26 extending along the first imaginary plane P1. The planar portion 26 is configured to have a roughness greater than or equal to 3 nm and less than or equal to 10 nm (i.e., from 3 nm to 10 nm). As shown in FIG. 3, the first inductor wires 30 are provided along a second imaginary plane P2. The second imaginary plane P2 is spaced apart from the first imaginary plane P1 in the first direction Z and extends parallel to the first imaginary plane P1. The term “parallel” includes “substantially parallel”. With this configuration, it is possible to improve the efficiency of obtaining inductance while ensuring the adhesion of the magnetic layer 20. For example, when the roughness of the planar portion 26 of the magnetic layer 20 is less than 3 nm, the contact area of the magnetic layer 20 reduces, with the result that the adhesion decreases. When the roughness of the planar portion 26 of the magnetic layer 20 is greater than 10 nm, the crystal structure of magnetic material included in the magnetic layer 20 becomes random, and the uniaxial magnetic anisotropy of the magnetic layer 20 collapses, so there is a possibility that the efficiency of obtaining inductance cannot be improved.

The “roughness” is, for example, the arithmetic mean surface roughness Ra obtained over a range of 10 μm of the planar portion 26. The arithmetic mean surface roughness Ra is obtained in accordance with JIS B 0601, for example, using a laser microscope VK-X1000 manufactured by Keyence Corporation. When it is difficult to obtain the roughness from a direction perpendicular to the planar portion 26, the line edge roughness (LER) obtained from a cross section perpendicular to the planar portion 26 may be used as the “roughness” of the planar portion 26.

In the present disclosure, any embodiment and/or modification among the above-described various embodiments and modifications may be combined as needed. The combinations of the embodiments and/or the modifications also include combinations of configurations included in the embodiments and/or the configurations included in the examples.

Although the present disclosure has been sufficiently described through the above-described embodiments and/or modifications with reference to the accompanying drawings, the above-described embodiments and/or modifications do not cover all aspects of the present disclosure. Various modifications and alterations will be apparent to those skilled in the art in the technical field of the present disclosure. Such modifications and alterations should be understood to be included within the scope of the present disclosure as long as the modifications and alterations do not fall outside the scope of the present disclosure.

What is claimed is:

1. An inductor component comprising
at least one inductor element including
a magnetic layer having uniaxial magnetic anisotropy,
a first inductor wire on one side of the magnetic layer in a first direction and extending along an imaginary plane that intersects the first direction,
a second inductor wire on the other side of the magnetic layer in the first direction, and
a first via portion electrically connecting the first inductor wire and the second inductor wire,
wherein
the first inductor wire, the second inductor wire, and the first via portion configure at least part of an inductor wound around an axis extending along a second direction that intersects the first direction, and
an absolute value of an angle defined between a hard axis or easy axis of the magnetic layer and the axis is from zero degrees to smaller than 10 degrees.

2. The inductor component according to claim 1, wherein
an absolute value of an angle defined between the hard axis and the axis is from zero degrees to smaller than 10 degrees.

3. The inductor component according to claim 1, wherein
the magnetic layer has a rectangular shape when viewed along the first direction, and
the easy axis extends along a long-side direction of the magnetic layer.

4. The inductor component according to claim 1, wherein
the magnetic layer includes an inorganic electrically insulating layer and an inorganic magnetic layer that are laminated along the first direction, and
a thickness, which is a dimension in the first direction, of the magnetic layer is less than the thickness of the first inductor wire and the thickness of the second inductor wire.

5. The inductor component according to claim 1, further comprising:
an external terminal having a recessed portion that is recessed toward the magnetic layer.

6. The inductor component according to claim 1, wherein
at least part of the first via portion overlaps the magnetic layer when viewed along the axis.

7. The inductor component according to claim 6, wherein
more than half of the magnetic layer overlaps the first via portion when viewed along the axis.

8. The inductor component according to claim 1, wherein
the first via portion penetrates the magnetic layer along the first direction.

9. The inductor component according to claim 1, further comprising:
a first electrically insulating layer covering the first inductor wire; and
a second electrically insulating layer that is farther from the magnetic layer in the first direction than the first electrically insulating layer and has a lower coefficient of linear expansion than the first electrically insulating layer.

10. The inductor component according to claim 9, further comprising:
a vertical wire penetrating the second electrically insulating layer along the first direction, the vertical wire being configured to be electrically connectable to an external circuit.

11. The inductor component according to claim 1, further comprising:
an element body having a first main surface and a second main surface respectively located at opposite ends in the first direction, the element body including the magnetic layer, the first inductor wire, the second inductor wire, and the first via portion; and
an external terminal on at least one of the first main surface and the second main surface, the external terminal being electrically connected to at least one of the first inductor wire and the second inductor wire, wherein
a surface roughness of the first main surface and a surface roughness of the second main surface are different from each other.

12. The inductor component according to claim 11, wherein
the external terminal is on the first main surface,
the element body has a recessed portion that is recessed from the first main surface toward the magnetic layer in the first direction, and
the first main surface is closer to the magnetic layer than the external terminal.

13. The inductor component according to claim 1, wherein
the magnetic layer is inside an outer periphery of the inductor component when viewed along the first direction.

14. The inductor component according to claim 1, further comprising:
external terminals including a first external terminal electrically connected to at least one of the first inductor wire and the second inductor wire, and a second external terminal that is a dummy terminal not electrically connected to either the first inductor wire or the second inductor wire, and
the second external terminal has a shape different from a shape of the first external terminal.

15. The inductor component according to claim 1, comprising:
a plurality of the inductor elements.

16. The inductor component according to claim 15, wherein
a spacing between the first inductor wires or the second inductor wires of the adjacent inductor elements varies along a direction in which the first inductor wires or the second inductor wires extend.

17. The inductor component according to claim 15, comprising
2N (where N is a natural number) of the inductor elements.

18. The inductor component according to claim 1, wherein
the magnetic layer has a through-hole at a center of the magnetic layer and extending along the first direction.

19. The inductor component according to claim 15, wherein
a first axis and a second axis that is parallel to the first axis and that does not overlap the first axis are configured as the axis,
a plurality of first sets of the inductors are wound around the first axis and a plurality of second sets of the inductors are wound around the second axis, and
a coupling coefficient of the first sets of the inductors is greater than a coupling coefficient of the second sets of the inductors.

20. The inductor component according to claim 1, wherein
the magnetic layer has a first end portion facing the first via portion in a third direction that intersects the first direction and the second direction,
the first via portion has a second end portion facing the magnetic layer in the third direction, and
the first end portion and the second end portion are inclined in the same direction relative to the first direction.

21. The inductor component according to claim 1, wherein
the magnetic layer along a first imaginary plane that intersects the first direction,
the first inductor wire is spaced apart from the first imaginary plane in the first direction and extends along a second imaginary plane that is parallel to the first imaginary plane, and
a roughness of a planar portion of the magnetic layer on the first imaginary plane is from 3 nm to 10 nm.
